(19) United States
(12) Patent Application Publication
(10) Pub. No.: US 2014/0379453 A1
(43) Pub. Date: Dec. 25, 2014

(54) Automated Payment, Reward Program Enrollment, and Redemption

(71) Applicant: Brian Booth, San Diego, CA (US)

(72) Inventor: Brian Booth, San Diego, CA (US)

(21) Appl. No.: 13/927,046

(22) Filed: Jun. 25, 2013

(51) Int. Cl. G06Q 30/02; G06Q 20/14

(52) U.S. Cl. CPC G06Q 30/0226; G06Q 20/14
USPC 705/14.27

(57) ABSTRACT

An automated method adapted to associate a consumer with a rewards program is described. The method includes: providing a bill to the consumer using a processing device; receiving payment information regarding the consumer; receiving biographical information regarding the consumer; and updating information regarding a user account associated with the rewards program. A software application adapted to process a payment and update rewards program information includes sets of instructions for: generating a bill for a set of goods or services provided to a consumer; receiving a method of payment from the consumer; determining an account associated with the method of payment; and updating the rewards program information associated with the account. An automated method of facilitating a redemption associated with a rewards program includes: receiving a bill associated with a consumer purchase; receiving payment information from the consumer; and applying at least a portion of a redemption balance to the bill.

### BACKGROUND

Many establishments (e.g., retailers, restaurants, service providers such as automotive service establishments, online commerce sites (or “e-commerce” sites, mobile device commerce utilities (or “m-commerce” utilities), etc.) may offer various loyalty or reward programs (e.g., “registered card” technology) that may calculate reward measures (e.g., by tabulating “points” associated with amounts spent on various items and/or types of items) and allow consumers to apply the reward measures to purchases (e.g., using a “redemption balance” of points) or to receive a cash back reward. In many cases, a consumer may be asked to join such a program while making a payment to the establishment (e.g., while checking out of a store, when paying a restaurant tab, etc.). When joining, a user may typically be required to fill in a form, answer a series of questions from an associate, and/or perform other tasks in order to provide registration information to the establishment.

After joining, a user may typically have to provide a membership card (or a code associated with an account such as a phone number) in order to participate in the loyalty program. In addition, an existing user may be required to perform additional steps in order to redeem rewards (e.g., by reducing the bill by redeeming some reward balance using a registered card then paying the remaining portion of the bill by applying a separate payment using a credit card).

Thus there exists a need for a solution that allows an establishment to provide a combined payment and enrollment scheme that allows consumers to quickly and easily enroll in a loyalty program and automatically associate the program with a payment method, eliminating the need for the consumers to provide a membership card or other enrollment information. In addition, there exists a need for a way to automatically redeem rewards at payment.

### BRIEF SUMMARY

Some embodiments provide a way to efficiently enroll new members (or update existing member information) in a rewards or loyalty program when a consumer is making a payment for goods and/or services. The rewards program may be associated with an establishment or set of establishments.

When the consumer initiates payment for goods or services (e.g., by swiping a credit card), some embodiments may automatically collect information regarding the consumer (e.g., by retrieving information from a swiped credit card) and pre-populate various fields of an enrollment form (e.g., name, credit card number, etc.).

Some embodiments may manually collect additional information (e.g., email address, user preferences, etc.). The collected information may be used to enroll the consumer in the rewards program and automatically associate the payment method used by the consumer with the rewards account. Subsequently, if the consumer uses the same payment method at an establishment associated with the rewards program, the user's reward information may be automatically updated and/or applied by some embodiments, as appropriate. Likewise, if the consumer uses the same payment method at a different establishment associated with a different rewards program (after having signed up with a first rewards program), any required enrollment information may be automatically retrieved from the existing account and applied to the new rewards account.

Some embodiments may collect and/or generate information regarding a “bill” (which may include information associated with a receipt, purchase order, invoice, online shopping cart or checkout information, and/or other appropriate sources of information related to a purchase). Such information may include a list of goods and/or services, charges associated with each list item, etc. In some embodiments, the information may be associated with various reward rules (e.g., categories of rewards, reward rates, etc.) and/or other information (e.g., payment method, establishment location, etc.).

Some embodiments may automatically redeem a rewards balance (or a portion thereof) to apply to a bill based on received payment information. Such a redemption of rewards may be based at least partly on various appropriate factors (e.g., accumulated points, amount of the bill, type(s) of purchase(s), user preference or selection, etc.).

The information associated with each bill, enrollment, redemption, and/or other operations associated with some embodiments may be collected and provided to various parties. Such information may be collected at various appropriate times in various appropriate ways (e.g., through a web-based dashboard, via one or more application programming interfaces (APIs), etc.).

One exemplary embodiment of the invention provides an automated method adapted to associate a consumer with a rewards program. The method includes: providing a bill to the consumer using a processing device; receiving payment information regarding the consumer; receiving biographical information regarding the consumer; and updating information regarding a user account associated with the rewards program.

A second exemplary embodiment of the invention provides a software application adapted to process a payment and update rewards program information. The application includes sets of instructions for: generating a bill for a set of goods or services provided to a consumer; receiving a method of payment from the consumer; determining a user account associated with the method of payment; and updating the rewards program information associated with the user account.

A third exemplary embodiment of the invention provides an automated method of facilitating a redemption associated with a rewards program. The method includes: receiving a bill associated with a consumer purchase at a payment processing device; receiving payment information from the consumer; retrieving user account information associated with the consumer, wherein the user account information comprises a redemption balance; automatically applying at least a portion of the redemption balance to the bill; and processing the received payment information to settle any remaining portion of the bill.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGs.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a conceptual system used by some embodiments;

FIG. 2 illustrates a schematic block diagram of a conceptual software architecture used by some embodiments of the system of FIG. 1;

FIG. 3 illustrates a schematic block diagram of a conceptual client-side software application provided by some embodiments;

FIG. 4 illustrates a schematic block diagram of a conceptual server-side software application provided by some embodiments;

FIG. 5 illustrates a data structure diagram of conceptual data structures used by some embodiments;

FIG. 6 illustrates a flow chart of a conceptual process used by some embodiments to facilitate payment and/or enrollment;

FIG. 7 illustrates a flow chart of a conceptual process used by some embodiments to perform enrollment of a new member;

FIG. 8 illustrates a flow chart of a conceptual process used by some embodiments to apply a redemption;

FIG. 9 illustrates a flow chart of a conceptual process used by some embodiments to update information associated with an existing member;

FIG. 10 illustrates a flow chart of a conceptual process used by some embodiments to optimize post-transaction marketing;

FIG. 11 illustrates a flow chart of a conceptual process used by some embodiments to provide analytic data to third parties;

FIG. 12 illustrates a message flow diagram of a conceptual communication protocol used by some embodiments to facilitate payment and/or enrollment;

FIG. 13 illustrates various graphical user interfaces (GUIs) and associated sub-elements provided by some embodiments to allow a user to participate in one or more programs offered by some embodiments; and

FIG. 14 conceptually illustrates a schematic block diagram of a computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Several more detailed embodiments of the invention are described in the sections below. Section I provides a conceptual description of a system architecture used by some embodiments. Section II then describes conceptual software architectures used by some embodiments. Next, Section III describes various methods of operation used by some embodiments. Section IV describes various example GUI elements provided by some embodiments. Lastly, Section V describes a computer system which implements some of the embodiments of the invention.

### I. System Architecture

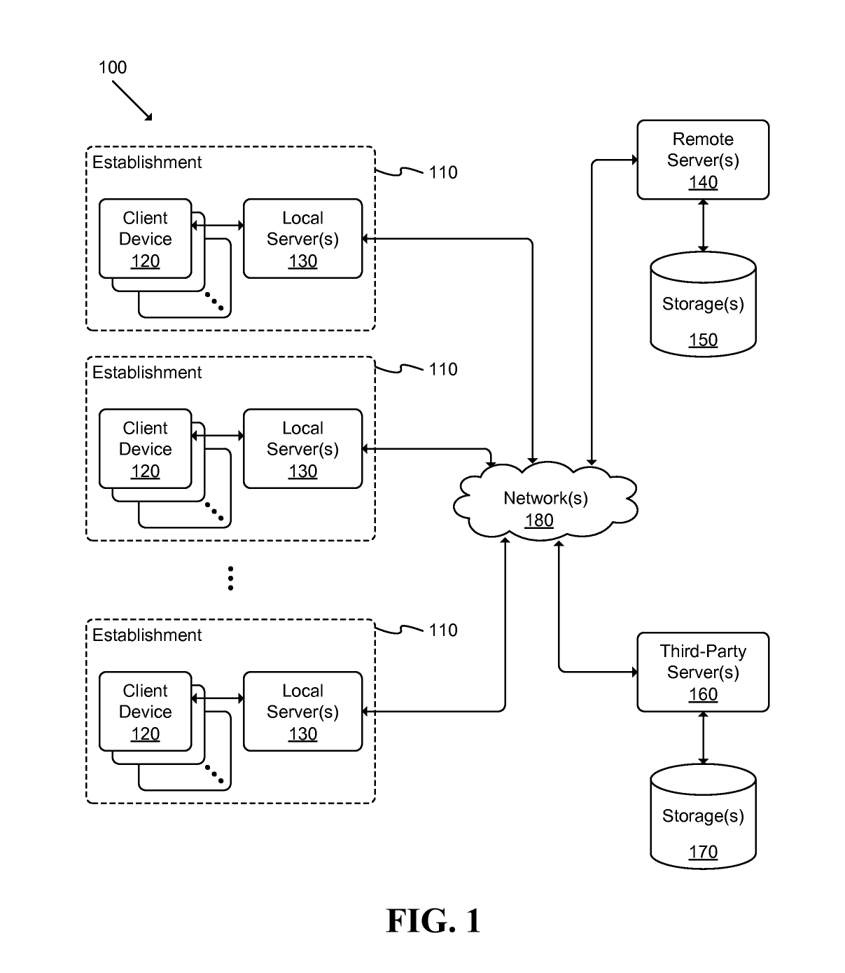

FIG. 1 illustrates a schematic block diagram of a conceptual system 100 used by some embodiments. Specifically, this figure shows the various communication pathways among the system elements. As shown, the system may include one or more establishments 110, each establishment associated with one or more client devices 120 and local servers 130, at least one remote server 140 with an associated set of storages 150, a third party server 160 with an associated set of storages 170, and one or more networks 180.

Each establishment 110 may be a physical (and/or virtual) collection of devices that are associated with a single entity (e.g., a restaurant, a retail store location, an airplane, a train, etc.). Each client device 120 may be an electronic device capable of receiving and processing payment information (e.g., a mobile device such as a smartphone or tablet, a point-of-sale device such as a register or terminal, a dedicated credit card swipe device, etc.) and may be associated with a particular establishment 110. Each local server 130 may be an electronic device (e.g., a computer, a network interface, etc.) that is able to interact with the various client devices 120 associated with a particular establishment. In some embodiments, the local server 130 may provide the functionality of a client device 120 and may operate without any associated client devices. Each local server 130 may be able to access one or more networks. In some embodiments, a client device 120 may operate without a local server (e.g., the client device may be able to directly access one or more networks and/or perform other functions associated with the local server 130).

The remote server(s) 140 may include a set of devices (e.g., one or more computers) that is able to interact with each establishment 110. The remote servers 140 may be able to access a set of local storages 150, each storage able to store (and/or retrieve) data and/or instructions. The remote servers 140 and storages 150 may be associated with a first entity that is able to interact with the establishments 110 (e.g., through mutually-established protocols, using software provided by the first entity, etc.). Such a first entity may facilitate a payment and enrollment, redemption, and/or other appropriate process by interacting among the establishments 110 and/or appropriate third parties.

The third-party server(s) 160 may include a set of devices that are able to be accessed by the system 100. The third party severs 160 may be able to access a set of local storages 170, each storage able to store (and/or retrieve) data and/or instructions associated with a third-party system. The third-party servers 160 and/or storages 170 may be associated with various third-party entities (e.g., marketing systems, data mining systems, payment processing systems, etc.). Such so called third-party entities may also include entities associated with one or more establishments 110 (e.g., a regional restaurant chain with multiple franchisees, a retailer with multiple store locations, etc.).

The set of networks 180 may include various local and/or distributed networks (e.g.,

Ethernet, wireless local area or “Wi-Fi” networks, the Internet, cellular communication networks, etc.) that may be accessed by the various elements of the system 100. In some embodiments, the set of networks 180 may include various devices (not shown) and/or other sub-elements such as servers, storages, interfaces, etc. that may allow interaction among one or more networks, devices, etc.

The operation of system 100 will be described in more detail below in Section III.

One of ordinary skill in the art will recognize that the system 100 may be implemented in various different ways without departing from the spirit of the invention. For instance, different specific elements may be included or omitted. As another example, different communication pathways may be used. As still another example, various single elements may be divided into multiple elements and/or multiple elements may be combined into a single element.

### II. Software Architecture

Sub-section II.A describes a conceptual software system provided by some embodiments. Sub-section II.B then describes a client-side application provided by some embodiments. Next, sub-section II.C describes a server-side application provided by some embodiments. Lastly, sub-section II.D describes conceptual data structures used by some embodiments.

A. System-Level

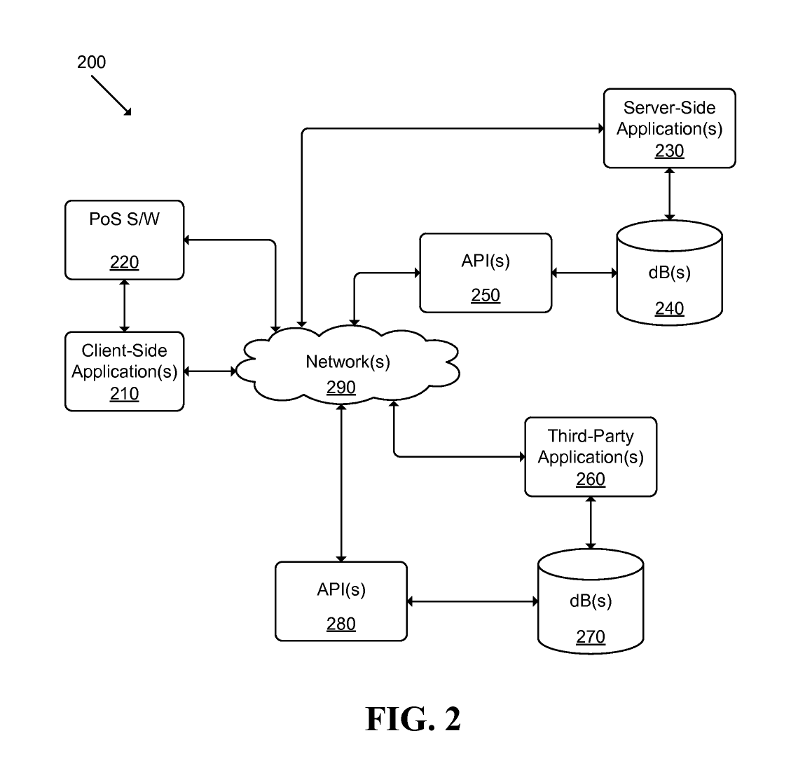

FIG. 2 illustrates a schematic block diagram of a conceptual software architecture 200 used by some embodiments of system 100 and/or other systems. Specifically, this figure shows various conceptual software elements that may allow the components of system 100 to interact. As shown, the software architecture 200 includes one or more client-side application 210, a set of point-of-sale software elements 220, one or more server-side applications 230, a set of server databases 240, one or more server APIs 250, a set of third-party applications 260, a set of third-party databases 270, one or more third-party APIs 280, and a set of network elements 290.

The client-side application 210 may be adapted to be executed by a client device (e.g., client device 120 described above) and may allow the client device to perform various system functions. The client-side application 210 may receive information from one or more users (e.g., a cashier, a server, a consumer, etc.), communicate with point-of-sale software running on a local server (e.g., local server 130 described above), provide information to one or more users and/or consumers (e.g., a receipt, form information, etc.), and/or perform other appropriate functions.

The point-of-sale software 220 may be adapted to be executed by a local server or other appropriate device (e.g., local server 130 described above) and may allow the local server to perform various system functions. The point-of-sale software 220 may receive information from one or more users (e.g., a cashier, a server, etc.) and/or a set of client-side applications, communicate across one or more network communication elements 290 joining one or more networks (e.g., networks 180 described above), provide information to one or more users and/or consumers (e.g., a receipt, form information, etc.), and/or perform other appropriate functions (e.g., receiving payment information, generating receipts, etc.).

The server-side application 230 may be adapted to be executed by a remote server or other appropriate device (e.g., remote server 140 described above) and may allow the remote server to perform various system functions. The server-side application 230 may be able to communicate among multiple sets of client-side applications (where each set may be associated with an establishment), communicate across one or more network communication elements 290 joining one or more networks (e.g., networks 180 described above), and/or perform other appropriate functions. In some embodiments, the server-side application 230 may be implemented as a plug-in that may be able to drive the operation of a client-side application and/or integrate with appropriate point of sale software.

The databases 240 may include data stored by some embodiments using an appropriate storage (e.g., storage 150 described above). Such data may include, for instance, data associated with one or more establishments or sets of establishments, data associated with various consumers (e.g., information regarding purchases made at participating establishments, loyalty account information, payment method information, etc.), and/or other appropriate data. The databases 240 may be accessed through the server-side application 230 or through one or more APIs 250, as appropriate. Such APIs may allow various external entities (e.g., third-party analysis firms, establishment-clients, etc.) to access data stored in the various databases 240.

The third-party application 260 may be adapted to be executed by a third-party server or other appropriate device (e.g., third-party server 160 described above) and may allow the third-party server to interact with the system of some embodiments. The third-party application 230 may be able to communicate among multiple sets of client-side applications (where each set may be associated with an establishment), communicate across one or more network communication elements 290 joining one or more networks (e.g., networks 180 described above), and/or perform other appropriate functions.

The databases 270 may include data stored by some embodiments using an appropriate storage (e.g., storage 170 described above). Such data may include, for instance, data associated with one or more third-parties (e.g., payment processing entities, research firms, etc.) and/or other types of data. The databases 270 may be accessed through the third-party application 260 or through one or more APIs 280, as appropriate. Such APIs may allow various external entities (e.g., the server-side application 230, client-side applications, point-of-sale software, etc.) to access data stored in the various databases 270.

The network communication elements 290 may include various interfaces, protocols, etc. that may allow the various software components (and/or the associated system elements) to communicate among each other.

One of ordinary skill in the art will recognize that the architecture 200 may be implemented in various different ways without departing from the spirit of the invention. For instance, different specific elements may be included or omitted. As another example, different communication pathways may be used. As still another example, various single elements may be divided into multiple elements and/or multiple elements may be combined into a single element.

B. Client-Side

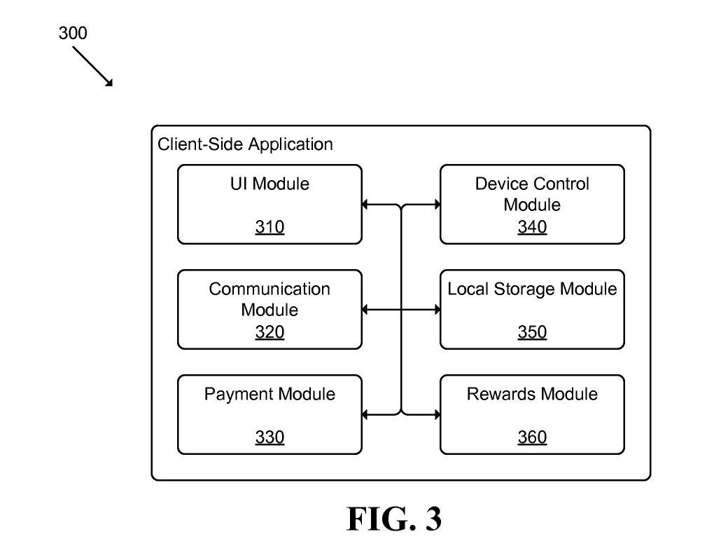

FIG. 3 illustrates a schematic block diagram of a conceptual client-side software application 300 provided by some embodiments (e.g., client-side application 210 described above). As shown, the application 300 may include a user interface (UI) module 310, a communications module 320, a payment module 330, a device control module 340, a local storage module 350, and a rewards module 360.

The UI module 310 may be adapted to generate various user interface elements and/or to process various user inputs. Such a UI module may allow, for example, a user to enter information onto a touch screen where the information is then collected by the client-side application.

The communication module 320 may allow the other elements of the client-side application 300 to interact with various external applications (e.g., a server-side application accessed through a set of network interfaces, a local server accessed across a local network, etc.).

The payment module 330 may be adapted to provide various functionality associated with payment processing such as collecting payment information (e.g., by receiving swiped credit card information, by receiving payment information entered by a consumer, etc.).

The device control module 340 may be adapted to allow the client-side application 300 to interact with various client device components, as appropriate. For instance, in some embodiments, the device control module 340 may allow the application 300 to control a touch screen element associated with the device. As another example, a point-of-sale terminal may be directed to display various instructions, forms, etc.

The local storage module 350 may be adapted to allow the client-side application 300 to access local storage associated with a client device.

The rewards module 360 may be adapted to interact with various remote servers, local servers, and/or third-party components to collect, analyze, and/or distribute rewards information. Such information may be associated with a loyalty or reward program which may be associated with one or more establishments.

One of ordinary skill in the art will recognize that the application 300 may be implemented in various different ways without departing from the spirit of the invention. For instance, different specific elements may be included or omitted. As another example, different communication pathways may be used. As still another example, various single elements may be divided into multiple elements and/or multiple elements may be combined into a single element.

C. Server-Side

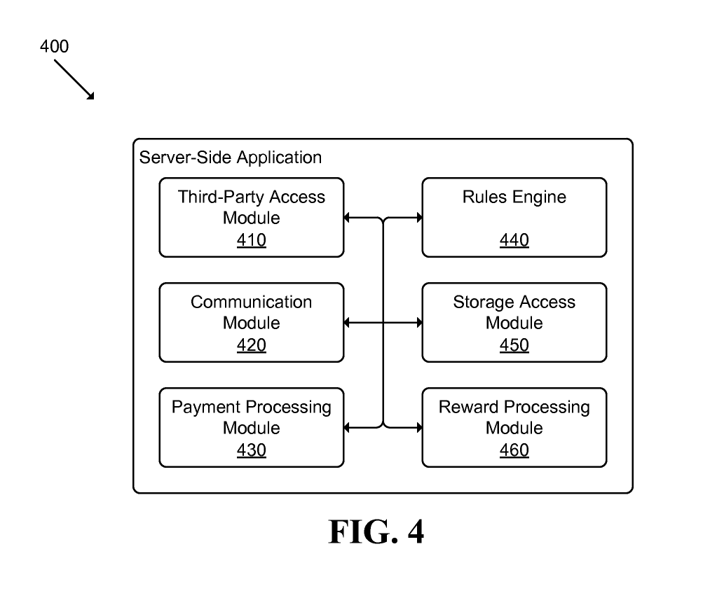

FIG. 4 illustrates a schematic block diagram of a conceptual server-side software application 400 provided by some embodiments (e.g., server-side application 230 described above). As shown, the application may include a third-party access module 410, a communication module 420, a payment processing module 430, a rules engine 440, a storage access module 450, and a reward processing module 460.

The third-party access module 410 may allow the system 400 to interact with various third-party applications. Such a module 410 may include one or more APIs.

The communication module 420 may allow the other elements of the server-side application 400 to interact with various external applications (e.g., a client-side application accessed through a set of network interfaces, a third-party application, etc.).

The payment processing module 430 may be adapted to provide various functionality associated with payment processing such as collecting payment information (e.g., by receiving information from a client-side application), formatting the information for submission to a third-party payment processor, and/or interpreting a set of responses received from a payment processor.

The rules engine 440 may be adapted to evaluate consumer information in relation to a set of program evaluation criteria to generate an appropriate set of actions based on a consumer (and/or third-party) interaction. For instance, some rewards programs may provide a bonus reward to a first time customer. As another example, some rewards programs may provide various promotional materials based on evaluations of consumer behavior.

The storage access module 450 may be adapted to allow the server-side application 400 to access local storage associated with the server (e.g., storages 150 described above).

The reward processing module 460 may be adapted to interact with various client devices, remote servers, and/or third-party components to collect, analyze, and/or distribute rewards information. Such information may be associated with a loyalty or reward program which may be associated with one or more establishments.

One of ordinary skill in the art will recognize that the application 400 may be implemented in various different ways without departing from the spirit of the invention. For instance, different specific elements may be included or omitted. As another example, different communication pathways may be used. As still another example, various single elements may be divided into multiple elements and/or multiple elements may be combined into a single element.

D. Data Structures

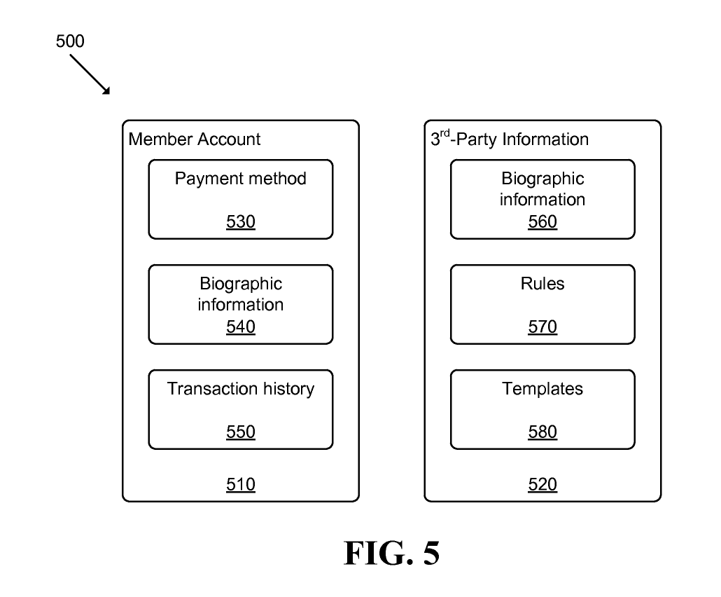

FIG. 5 illustrates a data structure diagram of conceptual data structures 500 used by some embodiments. Such data structures may be used by the software applications described above in reference to FIGS. 2-4. As shown in FIG. 5, the data structures 500 may include a member account 510 and third-party information 520.

The member account element 510 may be associated with a particular user (or set of users such as a family, business, etc.) that has enrolled in a reward program. The member account may include a payment method 530 (e.g., credit card information, online payment account information, etc.), biographic information 540 regarding the user (e.g., name, email address, etc.). The transaction history 550 may include information related to previous interactions between the user and the establishment associated with the rewards program.

The third-party information 520 may be associated with a particular third party (e.g., an establishment or group of establishments, a payment processing service, etc.). The third-party information element may include biographic information 560 (e.g., the name of the establishment, the type of reward program, etc.), a set of rules 570 (e.g., criteria for sending offers to a consumer, criteria for generating a reward to a user, etc.), and a set of templates 580 (e.g., forms, promotion email templates, etc.). The third-party information 520 may be collected, updated, and/or otherwise maintained by the system of some embodiments (e.g., each set of rules may be associated with an establishment and maintained by the system).

One of ordinary skill in the art will recognize that the data structures 500 are conceptual in nature and different embodiments may implement the structures in various different ways without departing from the spirit of the invention. For instance, some embodiments may include additional specific elements and/or sub-elements and/or may omit specific elements and/or sub-elements. As another example, various sub-elements may be combined into a single element or a single element may be divided into multiple sub-elements.

### III. Methods of Operation

Sub-section III.A provides a conceptual description of a payment process of some embodiments. Sub-section III.B then describes a conceptual enrollment process provided by some embodiments. Sub-section III.C follows with a description of a conceptual redemption process provided by some embodiments. Next, sub-section III.D describes a conceptual process used by some embodiments to update existing account information. Sub-section III.E then provides a description of a conceptual process used by some embodiments to facilitate post-transaction marketing. Next, sub-section III.F describes a conceptual process used by some embodiments to collect and provide user data. Lastly, sub-section III.G describes a message flow used by some embodiments to implement various operations.

The various processes described below may be implemented using various combinations of the hardware elements described above in reference to FIG. 1, the software components described above in reference to FIGS. 2-4, the data structures described above in reference to FIG. 5 and/or other appropriate elements. In addition, the various processes described below (or portions thereof) may be implemented in various combinations as appropriate to provide various combinations of features (e.g., payment and enrollment, payment and reward redemption, etc.).

A. Payment

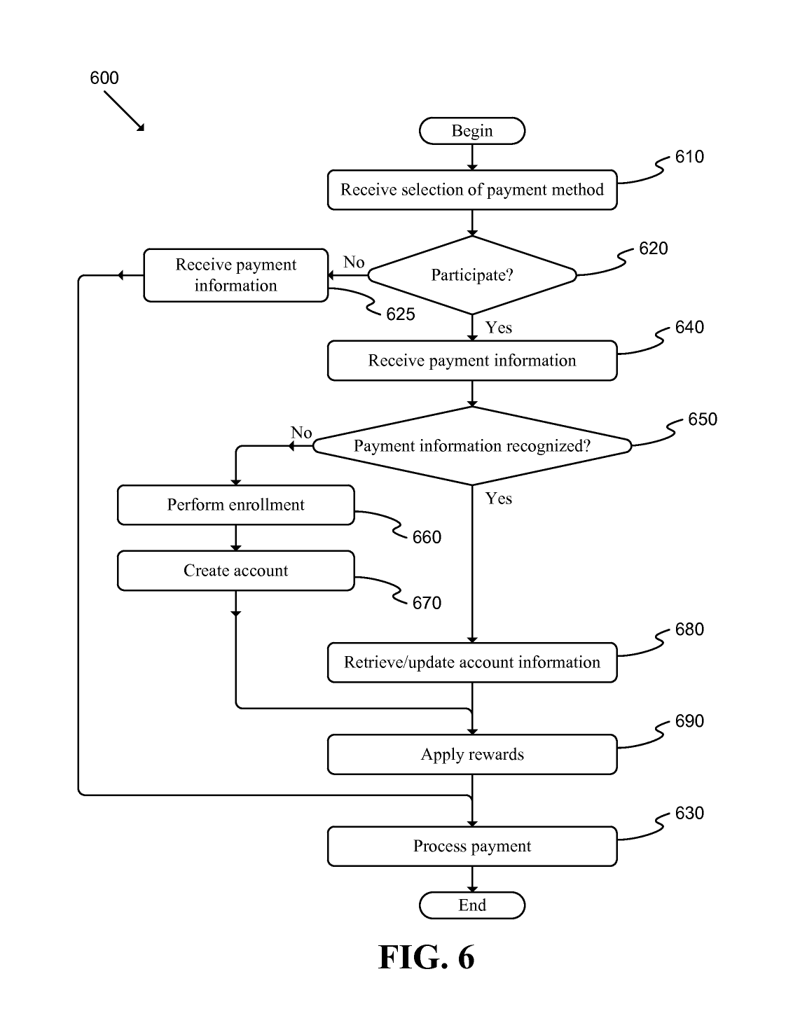

FIG. 6 illustrates a flow chart of a conceptual process 600 used by some embodiments to facilitate payment and/or enrollment. Such a process may begin, for instance, when a consumer is provided payment options using a tableside tablet device, when a server or cashier initiates a payment operation, etc. Next, the process may receive (at 610) selection of a payment option. Available options (e.g., pay with cash, pay with credit card, pay with online account, etc.) may be displayed in various appropriate ways (e.g., as a list, as a set of selectable buttons, etc.) and a selection from among the options may be received in various appropriate ways (e.g., using a touchscreen, using a display screen and keypad, etc.).

In some embodiments, the process may perform different sets of operations depending at least partly on the selected payment option (for instance, if “cash” is selected as the payment option, the process may simply display or print a bill and end).

Next, the process may offer (not shown) one or more incentives to enroll to a reward program and/or otherwise encourage users to participate. Such an offer may include, for instance, marketing materials, a one-time discount, etc. The process may then determine (at 620) whether the recipient of the offer wishes to participate in the reward program. Such a determination may be made based on input received from the recipient, entered by a server or other associate, and/or other appropriate ways. If the process determines that the recipient does not wish to participate, the process may receive (at 625) payment information and then process (at 630) the payment. Such payment information may be received in various appropriate ways (e.g., swiping a credit card, entering credit card or banking information, providing account information for a web-based payment method, etc.) and processed as appropriate.

Alternatively, if the process determines that the recipient does want to participate, the process may then receive (at 640) payment information. Such payment information may be received in various appropriate ways (e.g., swiping a credit card, entering credit card or banking information, providing account information for a web-based payment method, etc.).

Process 600 may then determine (at 650) whether the payment information is recognized (and/or whether the user is an existing user). Such a determination may be made in various appropriate ways (e.g., by comparing the payment information to a database of accounts, by prompting the user to indicate whether the user is a new or existing member, etc.).

In some embodiments, after a consumer has enrolled in the rewards program using a particular payment method, the user will automatically be recognized as an existing member when the same payment method is used, without requiring any additional action by the user. For example, when a user swipes a credit card as payment (e.g., using a fixed terminal, using a mobile device such as a tablet, etc.) and the credit card is determined to be associated with an existing account, the reward information may be updated and/or applied to the bill without requiring the user to make any additional selections or take any actions other than those necessary to process the payment as if the user was not enrolled.

If the process determines (at 650) that payment information is not recognized, the process may perform (at 660) enrollment and create (at 670) an account. Alternatively, if the process determines (at 650) that payment information is not recognized and the process also determines (not shown) that the user has already enrolled (e.g., by receiving an indication from the user, by determining that an email is already associated with an account, etc.), the process may determine whether to update the account information associated with the user (e.g., by adding another payment method to the account). Such a determination may be made based on various appropriate factors (e.g., user selection, default setting, etc.).

Enrollment may include the user being asked to provide an email address and/or other information. In some embodiments, the payment method and information associated with the method (e.g., the name, address, etc. of the recipient) may be automatically retrieved from the payment information received at 620 (e.g., a consumer's name may be encoded, along with an account number and/or other information on the magnetic strip on the back of a credit or bank card, a consumer's name may be known to a web-based payment service, etc.). Enrollment will be described in more detail in reference to process 700 below.

If process 600 determines (at 650) that the payment information is recognized, the process may retrieve and/or update (at 680) account information associated with the user. Such retrieval and/or update may include communicating with a remote server or other element to determine a status of the user (e.g., number of points accumulated, purchase history, etc.) and/or sending information to the server regarding the current interaction (e.g., amount paid, participation election, etc.). Updating of account information will be described in more detail in reference to process 900 below.

After retrieving and/or updating (at 680) the account information or after performing (at 660) enrollment and creating (at 670) an account, process 600 may apply (at 690) rewards to the account. Such rewards may be provided instantly in some embodiments (e.g., by automatically reducing the amount due from the consumer). Alternatively, the user's account may be updated to reflect additional rewards that have not been redeemed. In some embodiments, a user may be able to select (not shown) from among a set of available rewards to apply. For instance, a list of options may be presented (e.g., apply points to balance, redeem points for additional merchandise, etc.) and a selection received from among the listed options.

After applying (at 690) the rewards or after receiving (at 625) the payment information, the process may process (at 630) payment for the transaction (e.g., by interacting with a third-party application and/or server to perform a credit card transaction, by interacting with a web-based service, etc.) and then may end.

Process 600 may be performed in various different ways without departing from the spirit of the invention. For instance, different embodiments may include different operations, omit various operations, and/or perform the operations in a different order than shown. Some embodiments may divide the process into a set of sub-processes or perform the process as a sub-process of a larger macro process.

B. Enrollment

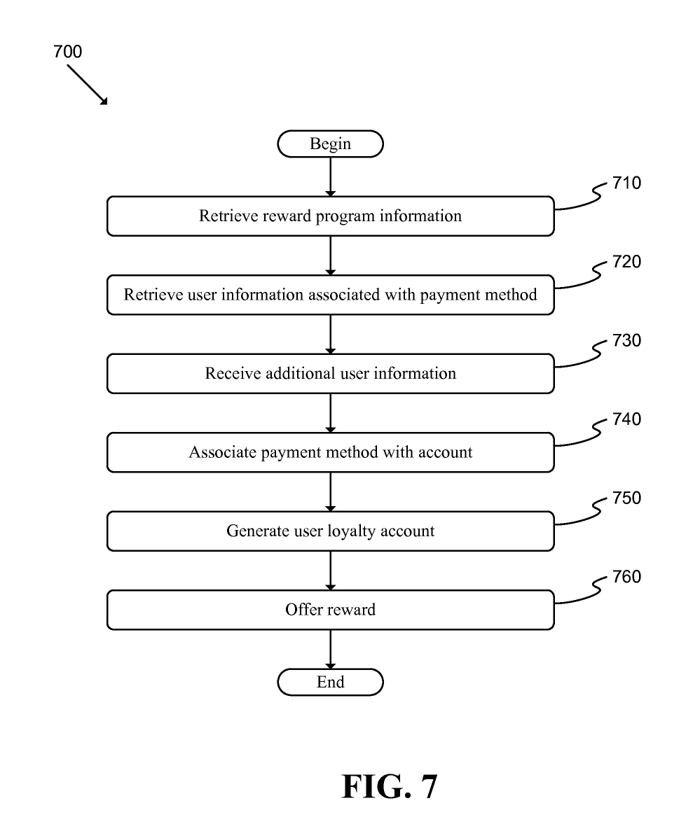

FIG. 7 illustrates a flow chart of a conceptual process 700 used by some embodiments to perform enrollment of a new member. Such a process may be performed, for example, when a user elects to participate in a rewards program and is identified as a new member.

As shown, the process may retrieve (at 710) reward program information. Such information may include biographic information regarding an establishment or chain, rules, etc. Next, the process may retrieve (at 720) user information associated with a payment method (e.g., name and credit card number, username, etc.). Such information may be retrieved in various appropriate ways depending on the payment method (e.g., payment information and biographic information may be retrieved from data stored in a magnetic strip on a bank card when the card is swiped, the information may be received from a third-party, etc.).

The process may then receive (at 730) additional user information. Such information may be received in various appropriate ways (e.g., by providing a user interface with various form elements such as text fields, check boxes, selection lists, etc. that allow a user to enter the information). The additional information may include contact and/or biographic information (e.g., email address, social networking page, birthday, mobile phone number, ZIP code, etc.), user preferences (e.g., prefer weekly emails, daily emails, etc.), and/or other appropriate information (e.g., number of times eating out per month, annual income, etc.). In some embodiments, various rewards, marketing materials, etc. may be based at least partly on the contact and/or biographic information.

Next, the process may associate (at 740) the payment method with the user's account information and generate (at 750) a user loyalty account. The user loyalty account and associated payment method may be stored using a remote server and storage.

The process may then offer (at 760) a reward (e.g., bonus reward, instant reward, etc.) and then may end. Such rewards may be based on various appropriate criteria (e.g., money spent, number of visits, status of the user (e.g., new member, repeat customer, etc.), etc.). Such rewards may be at least partly based on a set of rules associated with the reward program.

Process 700 may be performed in various different ways without departing from the spirit of the invention. For instance, different embodiments may include different operations, omit various operations, and/or perform the operations in a different order than shown. Some embodiments may divide the process into a set of sub-processes or perform the process as a sub-process of a larger macro process.

C. Redemption

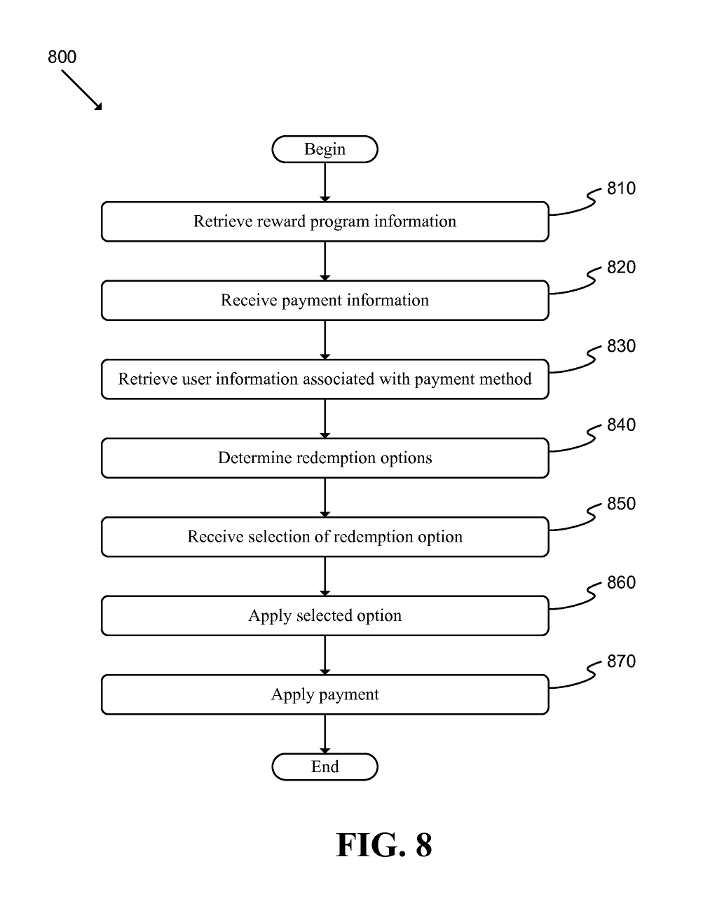

FIG. 8 illustrates a flow chart of a conceptual process 800 used by some embodiments to apply a redemption. Such a process may be performed, for example, when an existing user makes a purchase using a registered payment method at an establishment associated with a rewards program.

As shown, process 800 may retrieve (at 810) reward program information (e.g., categories, thresholds, etc.) and then receive (at 820) payment information (e.g., by receiving a swiped credit card) and then retrieving (at 830) user information associated with the payment method. Such information may be retrieved using an appropriate system and software of some embodiments. Alternative, new user information may be collected, if appropriate.

Next, the process may determine (at 840) the redemption options (e.g., apply points to a purchase, receive a gift or promotional item, etc.). Such redemption options may be included with the retrieved reward program information. The process may then receive (at 850) a selection of a redemption option (e.g., by receiving a user input, performing a default selection, etc.) and apply (at 860) the selected option (e.g., by reducing the bill by an amount associated with a number of reward points, by applying a promotional reward such as a free dessert, etc.). Finally, the process may apply (at 870) the payment (e.g., by sending credit card information to a third-party processor) and then may end.

Process 800 may be performed in various different ways without departing from the spirit of the invention. For instance, different embodiments may include different operations, omit various operations, and/or perform the operations in a different order than shown. Some embodiments may divide the process into a set of sub-processes or perform the process as a sub-process of a larger macro process.

D. Account Update

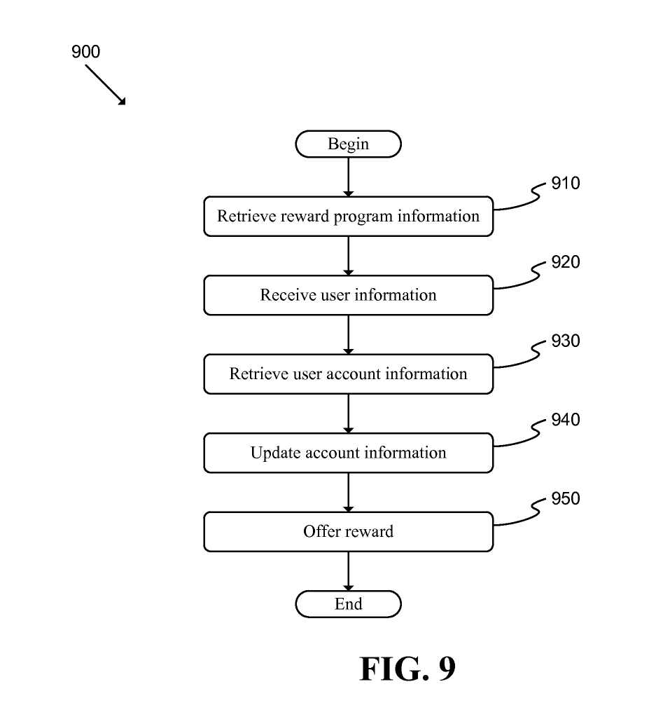

FIG. 9 illustrates a flow chart of a conceptual process 900 used by some embodiments to update information associated with an existing member. Such a process may be performed, for example, when a user elects to participate in a rewards program and is identified as an existing member. Alternatively, an existing member may make a selection indicating that the user's information has changed (e.g., payment method, address, preferences, etc.). As another example, an existing user may pay with a payment method that has not been previously associated with the rewards account (e.g., a new credit card may be used and the user also indicates that the user has previously enrolled). In some embodiments, the process may automatically be performed when a new credit card (or other payment method) is not recognized.

As shown, the process may retrieve (at 910) reward program information and receive (at 920) user information. Such reward program information may include biographic information regarding an establishment or chain, rules, etc. Such user information may include user account information (e.g., username and password, email address, etc.) and/or updates to the user information (e.g., a new payment method, an additional or updated phone number, an updated email address, etc.). For example, if a user swipes an unrecognized credit card and also indicates that the user is an existing user, the user may be asked to provide an email address associated with the rewards account (or a username and password, and/or other appropriate identifying information).

Next, the process may retrieve (at 930) user account information. The user account information may include biographic information, payment method information, information related to interaction history, and/or other appropriate data. Such account information may be retrieved based at least partly on the user information received at 920 (e.g., a username or email supplied by the user may be used to identify an account associated with the user such that the account information may be retrieved).

The process may then update (at 940) the user account information, if appropriate. For instance, if a credit card is used for payment and is not associated with any user account, but the user makes a selection indicating that the user has an existing account, the new payment method may be associated with the existing account (and thus automatically be recognized in the future, along with any other active payment methods).

Process 900 may then offer (at 950) a reward and then may end. Such rewards may be based on various appropriate criteria (e.g., money spent, number of visits, status of the user (e.g., new member, repeat customer, etc.), etc.). Such rewards may be at least partly based on a set of rules associated with the reward program.

Although process 900 has been described by reference to an example where a user adds a new payment method to an existing rewards account, a similar process may be used to add an existing payment method to a new rewards account. For instance, if a user has an existing rewards account with a first merchant associated with a payment method, and the user applies that payment method at a second merchant, some embodiments may automatically recognize the existence of an account with the first merchant and apply the user information (e.g., name, email, address, ZIP code, social media information, etc.) to creation of an account with the second merchant.

Process 900 may be performed in various different ways without departing from the spirit of the invention. For instance, different embodiments may include different operations, omit various operations, and/or perform the operations in a different order than shown. Some embodiments may divide the process into a set of sub-processes or perform the process as a sub-process of a larger macro process.

E. Post-Transaction Marketing

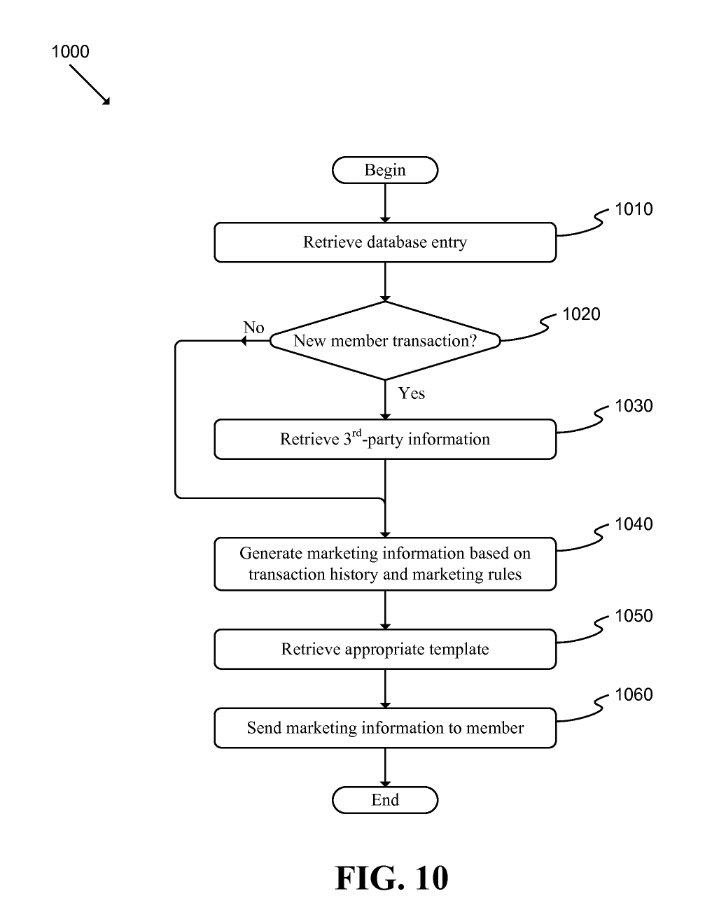

FIG. 10 illustrates a flow chart of a conceptual process 1000 used by some embodiments to optimize post-transaction marketing. Such a process may be executed at regular intervals (e.g., hourly, daily, weekly, etc.), may be executed based on various criteria (e.g., new user signup, update to existing account, during a holiday, at a specific time of day, etc.), and/or at other appropriate times (e.g., when a retailer initiates a promotional offer, when a threshold such as a spending threshold is reached, based on transaction history, based on customer spending behavior, etc.).

Such a process may trigger various appropriate actions such as receipt delivery (e.g., emailing a receipt with an included marketing offer, sending a marketing email with a coupon, etc.). In some embodiments, a receipt may include a selectable element (e.g., a URL) that may allow a user to provide information regarding the expense (e.g., names of people met, items discussed, etc.) that may then be compiled for the user to utilize (e.g., when the user prepares tax information).

As shown, the process may retrieve (at 1010) a database entry. Such a database entry may be associated with a reward program transaction performed using some embodiments. Next, the process may determine (at 1020) whether the transaction involves a new member. If the process determines that the transaction does involve a new member, the process may then retrieve (at 1030) third-party information. Such third-party information may include marketing information (e.g., email templates, promotional content, etc.) that may be retrieved from an establishment, chain, marketing firm, and/or other appropriate third party.

After retrieving (at 1030) the third-party information, or after determining (at 1020) that transaction does not involve a new member, the process may generate (at 1040) marketing information based at least partly on the user's transaction history and a set of marketing rules. Next, the process may retrieve (at 1050) an appropriate marketing template (e.g., an email template) and send (at 1060) the marketing information to the member.

Process 1000 may be performed in various different ways without departing from the spirit of the invention. For instance, different embodiments may include different operations, omit various operations, and/or perform the operations in a different order than shown. Some embodiments may divide the process into a set of sub-processes or perform the process as a sub-process of a larger macro process.

F. Merchant Dashboard

Some embodiments may allow various merchants (or “users”) such as establishments, groups of establishments, marketing organizations, etc. to access user (i.e., consumer) data. Such data may include any information related to user purchases made using the systems of some embodiments. The information may include user status information (e.g., new enrollment, existing member, purchase history, ZIP code, social media account information, etc.), payment information such as payment method, purchase information (e.g., a bill, a list of items, a total amount, timestamp, purchase location, etc.), establishment information (e.g., type, location, size, promotions, etc.), rewards information (e.g., rewards points accrued, rewards points redeemed, etc.), and/or other information that may be compiled by the system of some embodiments.

User data may be collected and/or compiled in various appropriate ways. For instance, some embodiments may continuously collect user data as the user data is received (e.g., when a user enrolls, when a user makes a payment with a registered merchant, etc.). As another example, user data may be collected from various establishments at various appropriate times and/or in various appropriate ways (e.g., a store may provide information at regular intervals, a regional chain may provide information formatted in a particular way, etc.). Such user data may include spending behavior, redemption behavior, demographic information, social media behavior (e.g., a tally of “likes” by enrolled users, sharing links with “friends”, forwarding messages or links, etc.), etc. The data may be collected and/or made available in real time (i.e., as the data is provided to the system of some embodiments, the data may immediately be made available to various users). In addition, in some embodiments such collected data may be used to provide rewards to enrolled users (e.g., by a providing a reward for “liking” a product or service, by awarding additional points when a user shares a link, etc.).

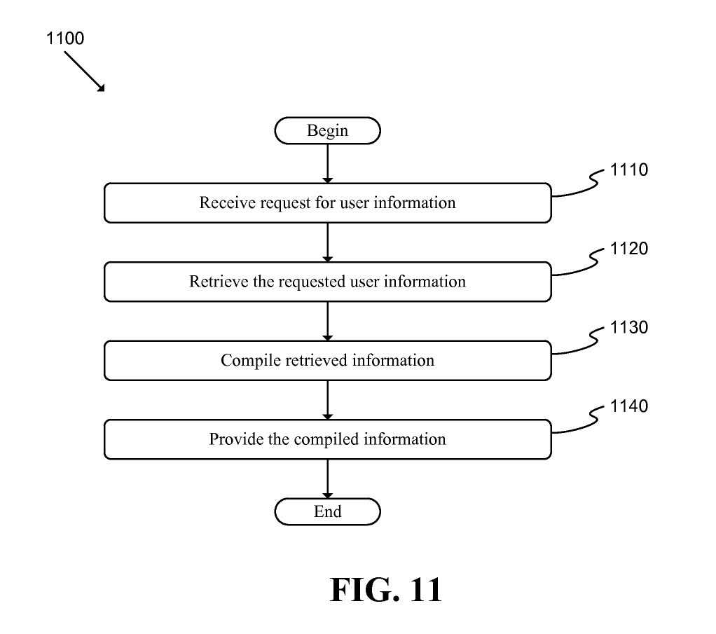

FIG. 11 illustrates a flow chart of a conceptual process 1100 used by some embodiments to provide analytic data to third parties. In some embodiments, such a process may be executed continuously as user information is received.

The process may receive (at 1110) a request (or “query”) for user information. Such user information may be aggregated in various appropriate ways, as desired by a merchant requesting the information (e.g., all users who have purchased more than a threshold amount over a recent time period, all users who enrolled within a specific time frame, etc.). Such a request may be received in various appropriate ways (e.g., through an API, via a web site or other such portal, through an application of some embodiments, as a formatted message, etc.). The request may include various appropriate parameters (e.g., consumer type, establishment type, purchase amount, etc.) that may be used to identify appropriate information based on the request.

Next, the process may retrieve (at 1120) the requested user information. Such information may be retrieved by, for instance, accessing a remote storage of some embodiments. Process 1100 may then compile (at 1130) the retrieved information. The information may be compiled in various appropriate ways (e.g., based on the requested elements, based on user preference, based on various protocols, etc.).

Finally, the process may provide (at 1140) the compiled information to the requestor and then may end. The information may be provided in various appropriate ways and/or formats based on various appropriate criteria, parameters, etc.

Process 1100 may be performed in various different ways without departing from the spirit of the invention. For instance, different embodiments may include different operations, omit various operations, and/or perform the operations in a different order than shown. Some embodiments may divide the process into a set of sub-processes or perform the process as a sub-process of a larger macro process.

G. Message Flow

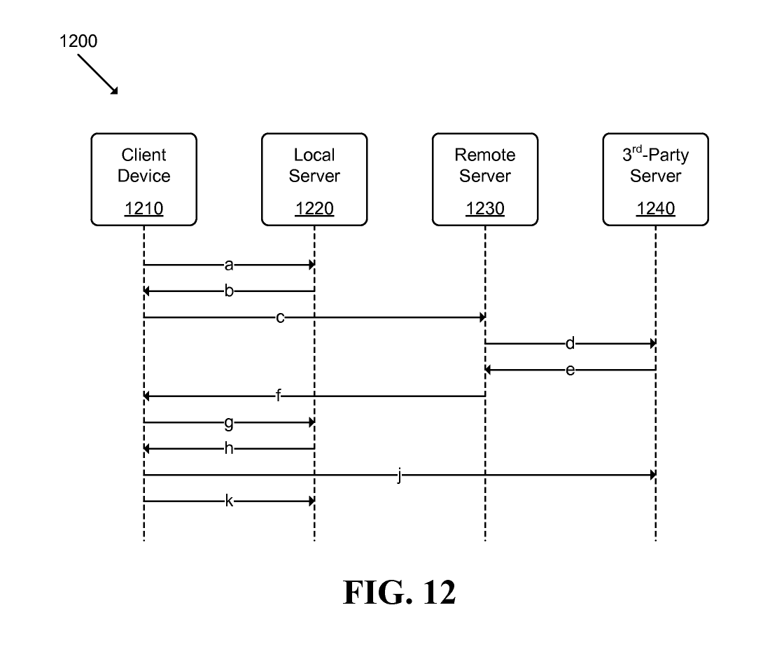

FIG. 12 illustrates a message flow diagram of a conceptual communication protocol 1200 used by some embodiments to facilitate payment and/or enrollment. As shown, the communication protocol may be implemented among various devices including a client device 1210, a local server 1220, a remote server 1230, and a third-party server 1240. The elements and message flow of FIG. 12 is presented for example purposes only. Many different message flows may occur depending on various relevant factors (e.g., available system elements and/or sub-elements, selections made by users, approval and/or denial of various requests to third parties or external systems, etc.).

In this example, the client device 1210 may be associated with a server at a restaurant, the local server 1220 may be a point-of-sale system used by the restaurant, the remote server 1230 may include a set of remote devices provided by the system of some embodiments, and the third-party server 1240 may include a set of remote devices provided by a third party payment processor.

During operation, a server may initiate checkout for a customer by making a selection using a client device and client-side application of some embodiments. Such a selection may cause a message, ‘a’, to be sent to the local server 1220 from the client device 1210. The local server 1220 may compile a bill or tab associated with the customer and send a response, ‘b’, that includes the bill (e.g., a listing of items purchased by the consumer, applicable taxes, etc.).

The client device 1210 may, in turn, send a message, ‘c’, to the remote server 1230 which may include the bill sent in response ‘b’ and information regarding a payment method for the user (e.g., credit card information swiped using the client device 1210) along with a request for processing. In addition, message ‘c’ may include information regarding user enrollment (for a new user) and/or updated payment information (e.g., when an existing user adds a new payment method). Such a message may include transaction information associated with the consumer interaction (e.g., bill amount, establishment location, etc.) that may be used to update reward program information associated with the user.

The remote server 1230 may receive message ‘c’ and generate and send a request, ‘d’ for processing to the third-party server 1240. Such a request may include payment information (e.g., credit card number, name, authorization code, etc.), amount to be paid, and/or other appropriate information. The third-party server may analyze the request ‘d’ and determine whether to process the payment. Such a determination may be made based on various appropriate criteria (e.g., credit limit of the user, reputation of the establishment, etc.).

The third-party server 1240 may send, to the remote server 1230, a response, ‘e’ that authorizes or rejects the payment request. Such a response may include various authorization codes, identifying information, etc. The remote server may, in turn, send a response, ‘f’ to the client device 1210 indicating the result of the payment processing and/or any associated information.

If the payment has been rejected, the client device 1210 may prompt the user to enter another form of payment and repeat messages ‘c’-‘f’ until a payment is authorized, at which point the client device 1210 may send a confirmation message, ‘g’ to the local server 1220 indicating the results of the payment processing. The local server may return a message, ‘h’ indicating that the payment has been applied and the consumer transaction is complete.

The client device 1210 may then send a message, ‘j’ to the third-party server 1240 verifying the completed transaction. Finally, the client device 1210 may send a termination message, ‘k’ to the local server 1220 indicating that the consumer transaction has been completed and all information sent to the remote server 1230.

One of ordinary skill in the art will recognize that the message flow diagram 1200 is presented for example purposes only and that different embodiments may communicate in various different ways. For instance, in some embodiments a client device may not be able to communicate directly with a remote server and may instead have to relay messages through a local server. As another example, in some embodiments, a client device may communicate directly with a third-party server without use of a remote server. In addition, different embodiments may send different sets of messages, among different devices, and/or in different orders than shown.

### IV. Graphical User Interface (GUI) Elements

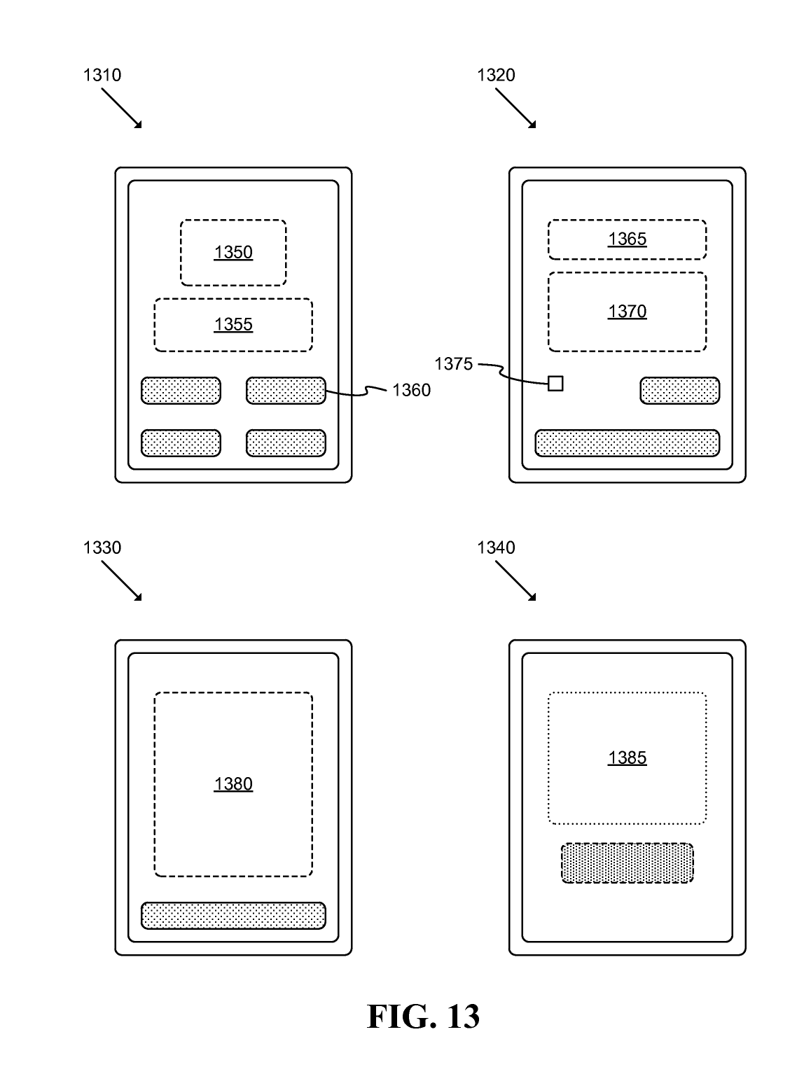

FIG. 13 illustrates various GUIs 1310-1340 and associated sub-elements provided by some embodiments to allow a user to participate in one or more programs offered by some embodiments. Such GUIs may be presented using an appropriate client device (e.g., client device 120 described above).

As shown, GUI 1310 may include a first graphic element 1350, a second graphic element 1355, and a set of selection elements 1360. In this example, the first graphic element 1350 may include an enrollment offer (e.g., enroll now to receive instant reward) while the second graphic element 1355 may include a listing of enrollment benefit and/or other information (e.g., “5% off future purchases”, “participation is free”, etc.). The set of selection elements 1160 may include buttons or other selectable elements and may be labeled with various appropriate selection options (e.g., “yes, enroll”, “no thanks”, “already a member”, “add new payment method”, etc.).

GUI 1320 may include multiple graphic elements 1365-1370, one or more input elements 1375, and various selection elements 1360. Graphic element 1365 may include a set of instructions for enrollment while graphic element 1370 may include a combination of displayed text and text entry fields (e.g., name, card number, email, etc.). Each input element 1375 may allow a user to acknowledge terms and conditions, privacy policy, etc. (e.g., by checking a box). The selection elements 1360 may include various options (e.g., enroll, checkout, etc.).

GUI 1330 may include a graphic element 1380 that may include a summary of the user's bill with rewards applied (if applicable) and a selection element 1360 (e.g., go to signature). GUI 1340 may include an input element 1385 (e.g., a region where a user may enter a signature on a touchscreen device) and a selection element 1360 (e.g., accept signature).

One of ordinary skill in the art will recognize that different embodiments may include various different GUI elements than those shown in the example of FIG. 13. For instance, some embodiments may include various GUIs intended for use by a server or cashier and may include appropriate elements for such use (e.g., table selection elements, menu selection elements, etc.). As another example, although the various GUIs were shown as using a “portrait” orientation, different embodiments (and/or different GUIs) may utilize a “landscape” orientation (and/or be able to automatically shift among orientations).

### V. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

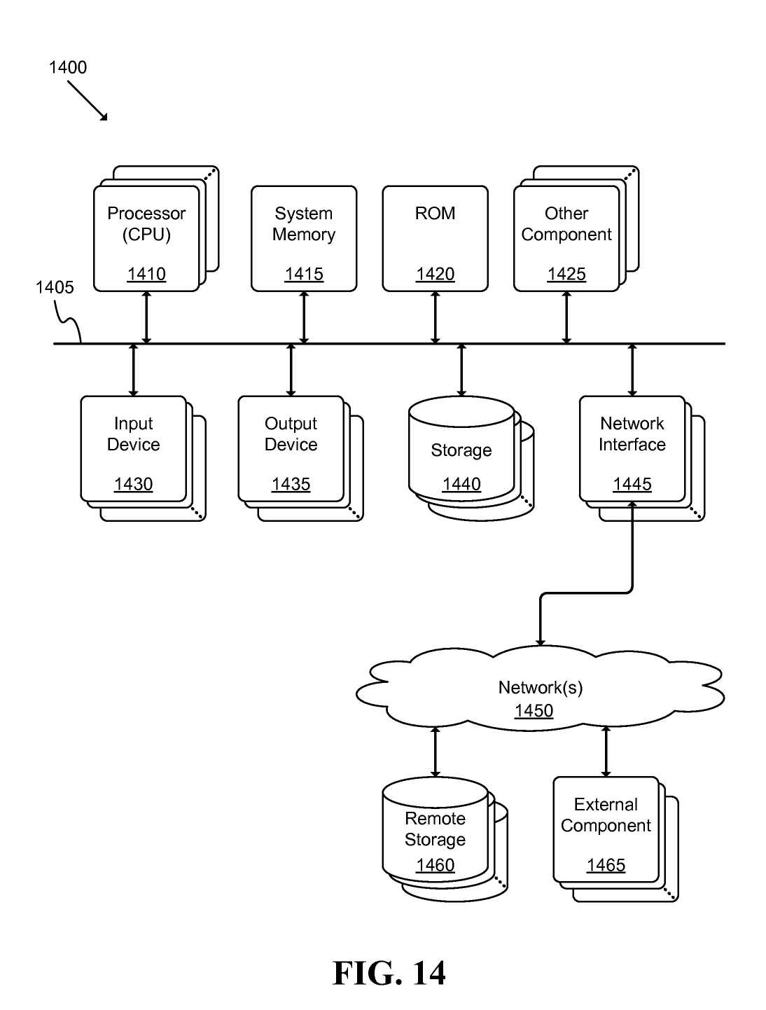

FIG. 14 conceptually illustrates a schematic block diagram of a computer system 1400 with which some embodiments of the invention may be implemented. For example, the system described above in reference to FIG. 1 may be at least partially implemented using computer system 1400. As another example, the processes described in reference to FIGS. 6-10 may be at least partially implemented using sets of instructions that are executed using computer system 1400.

Computer system 1400 may be implemented using various appropriate devices. For instance, the computer system may be implemented using one or more personal computers (“PC”), servers, mobile devices (e.g., a Smartphone), tablet devices, and/or any other appropriate devices.

The various devices may work alone (e.g., the computer system may be implemented as a single PC) or in conjunction (e.g., some components of the computer system may be provided by a mobile device while other components are provided by a tablet device).

Computer system 1400 may include a bus 1405, at least one processing element 1410, a system memory 1415, a read-only memory (“ROM”) 1420, other components (e.g., a graphics processing unit) 1425, input devices 1430, output devices 1435, permanent storage devices 1440, and/or network interfaces 1445. The components of computer system 1400 may be electronic devices that automatically perform operations based on digital and/or analog input signals. For instance, the various examples of GUI elements described above in reference to FIG. 13 may be at least partially implemented using sets of instructions that are run on computer system 1400 and displayed using the output devices 1435.

Bus 1405 represents all communication pathways among the elements of computer system 1400. Such pathways may include wired, wireless, optical, and/or other appropriate communication pathways. For example, input devices 1430 and/or output devices 1435 may be coupled to the system 1400 using a wireless connection protocol or system. The processor 1410 may, in order to execute the processes of some embodiments, retrieve instructions to execute and data to process from components such as system memory 1415, ROM 1420, and permanent storage device 1440. Such instructions and data may be passed over bus 1405.

ROM 1420 may store static data and instructions that may be used by processor 1410 and/or other elements of the computer system. Permanent storage device 1440 may be a read-and-write memory device. This device may be a non-volatile memory unit that stores instructions and data even when computer system 1400 is off or unpowered. Permanent storage device 1440 may include a mass-storage device (such as a magnetic or optical disk and its corresponding disk drive).

Computer system 1400 may use a removable storage device and/or a remote storage device as the permanent storage device. System memory 1415 may be a volatile read-and-write memory, such as a random access memory (“RAM”). The system memory may store some of the instructions and data that the processor uses at runtime. The sets of instructions and/or data used to implement some embodiments may be stored in the system memory 1415, the permanent storage device 1440, and/or the read-only memory 1420. Other components 1425 may perform various other functions.

Input devices 1430 may enable a user to communicate information to the computer system and/or manipulate various operations of the system. The input devices may include keyboards, cursor control devices, audio input devices and/or video input devices. Output devices 1435 may include printers, displays, and/or audio devices. Some or all of the input and/or output devices may be wirelessly or optically connected to the computer system.

Finally, as shown in FIG. 14, computer system 1400 may be coupled to a network 1450 through a network interface 1445. For example, computer system 1400 may be coupled to a web server on the Internet such that a web browser executing on computer system 1400 may interact with the web server as a user interacts with an interface that operates in the web browser. In some embodiments, the network interface 1445 may include one or more APIs. The network interface and associated network(s) 1450 may allow the system 1400 to access various remote storages 1460 and/or other external components 1465 (e.g., third-party servers).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1400 may be used in conjunction with the invention. Moreover, one of ordinary skill in the art will appreciate that many other system configurations may also be used in conjunction with the invention or components of the invention.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention may be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

I claim:

1. An automated method adapted to associate a consumer with a rewards program, the method comprising:
providing a bill to the consumer using a payment processing device;
receiving payment information regarding the consumer;
receiving biographical information regarding the consumer; and
updating information regarding a user account associated with the rewards program.

2. The automated method of claim 1, wherein receiving payment information regarding the consumer comprises receiving credit card information using a credit card swiping element.

3. The automated method of claim 1 further comprising associating the received payment information with the user account.

4. The automated method of claim 1 further comprising:
determining whether the received payment information is associated with an existing user account; and
retrieving the existing user account information if the received payment information is determined to be associated with an existing user account.

5. The automated method of claim 4, wherein updating information regarding the user account comprises modifying the existing user account information based at least partly on the bill.

6. The automated method of claim 4, wherein updating information regarding the user account comprises modifying the existing user account information based at least partly on the received payment information.

7. The automated method of claim 1 further comprising:
retrieving a set of rules associated with the rewards program;
evaluating the information regarding the user account based at least partly on the set of rules; and
determining a redemption to be applied to the bill based at least partly on the evaluation, wherein the reward comprises at least one of an instant reward and an accrued reward.

8. A software application adapted to process a payment and update rewards program information, the application comprising sets of processor-executable instructions for:
generating a bill for a set of goods or services provided to a consumer;
receiving a method of payment from the consumer;
determining a user account associated with the method of payment; and
updating the rewards program information associated with the user account based at least partly on the bill.

9. The software application of claim 8, wherein the method of payment is a credit card.

10. The software application of claim 8, wherein the rewards program is associated with one of a restaurant, a grocery store, an automotive service establishment, a mobile commerce utility, an e-commerce site, and a retailer.

11. The software application of claim 8 further comprising sets of instructions for generating a rewards program offer based at least partly on the updated rewards program information.

12. The software application of claim 8 further comprising sets of instructions for creating a new user account when determining that the method of payment is not associated with an existing user account.

13. The software application of claim 12 further comprising sets of instructions for generating an instant reward and offering the reward to the consumer.

14. The software application of claim 8, wherein:
the software application comprises a client-side application executed by a client device and a server-side application executed by a remote server, and
the client-side application and the server-side application are able to communicate across one or more networks.

15. An automated method of facilitating a redemption associated with a rewards program, the method comprising:
receiving a bill associated with a consumer purchase at a payment processing device;
receiving payment information from the consumer;
retrieving user account information associated with the consumer, wherein the user account information comprises a redemption balance;
automatically applying at least a portion of the redemption balance to the bill; and
processing the received payment information to settle any remaining portion of the bill.

16. The automated method of claim 15, wherein the received payment information comprises credit card information.

17. The automated method of claim 15 further comprising updating the user account information based on the bill.

18. The automated method of claim 15, wherein the user account information comprises an email address, a mobile telephone number, a birthday, and a ZIP code.

19. The automated method of claim 15, wherein automatically applying at least a portion of the redemption balance to the bill comprises reducing the bill by an amount proportional to the portion of the redemption balance.

20. The automated method of claim 15 further comprising generating a marketing offer associated with the consumer, based at least partly on the bill.
